(19) United States
(12) Patent Application Publication
(10) Pub. No.: US 2016/0278275 A1
(43) Pub. Date: Sep. 29, 2016

(54) THREE-POINT QUICK HITCH

(71) Applicant: Corbin Conway, Greenville, OH (US)

(72) Inventor: Corbin Conway, Greenville, OH (US)

(21) Appl. No.: 14/670,989

(22) Filed: Mar. 27, 2015

(51) Int. Cl. A01B 59/00; A01B 59/043; A01B 59/06

(52) U.S. Cl. CPC A01B 59/002; A01B 59/062; A01B 59/043

(57) ABSTRACT

A three-point quick hitch comprises a first arm and a second arm. A first adjustable attachment point couples to the first arm, and a second adjustable attachment point couples to the second arm. The first adjustable attachment point adjusts independently from the second adjustable attachment point; thus a control module includes two separate controls, one for each adjustable attachment point. A third attachment point couples between the first arm and the second arm, and an attachment mechanism to attach the three-point quick hitch to a working vehicle.

### BACKGROUND

Various aspects of the present invention relate generally to coupling implements to a working vehicle and more specifically to coupling implements to a working vehicle using a three-point quick hitch.

Working vehicles (e.g., tractors) may be used in agriculture to aid a farmer in preparing a field for planting, reaping, maintaining the field, etc. To do so, the working vehicle may use implements such as a spreader, a landscape rake, a mower, a plow, a seeder, etc. with a three-point coupler that couples to a three-point hitch of the working vehicle. When the implement is coupled to the working vehicle, a user may perform work with the implement.

### BRIEF SUMMARY

According to aspects of the present disclosure, a three-point quick hitch comprises a first arm and a second arm. A first adjustable attachment point couples to the first arm, and a second adjustable attachment point couples to the second arm. The first adjustable attachment point adjusts independently from the second adjustable attachment point; thus a control module includes two separate controls, one for each adjustable attachment point. A third attachment point couples between the first arm and the second arm, and includes an attachment mechanism to attach the three-point quick hitch to a working vehicle.

According to further aspects of the present disclosure, a method for attaching and detaching an implement to and from a working vehicle with a three-point quick hitch comprises backing a working vehicle with a three-point quick hitch to an implement with a coupler for the three-point hitch. When the three-point quick hitch is vertically aligned with the coupler of the implement, the three-point hitch is raised to engage with the coupler, but the user does not exit the vehicle to raise the hitch. Then, without the user exiting the working vehicle, using a first electrical signal, the user pivots a first adjustable attachment point of the three-point hitch such that the first adjustable attachment point secures a corresponding first coupler point of the implement. Before, after, concurrently, or a combination thereof, the user pivots a second adjustable attachment point of the three-point hitch using a second electrical signal such that the second adjustable attachment point secures a corresponding second coupler point of the implement where the second electrical signal is not the first electrical signal.

To detach the implement from the hitch, the user pivots, using a first electrical signal and independently of the user exiting the working vehicle, the first adjustable attachment point of the three-point hitch such that the first adjustable attachment point releases the corresponding first coupler point of the implement. Before, after, concurrently, or a combination thereof, the user pivots, using a second electrical signal independent from the first electrical signal and independently of the user exiting the working vehicle, the second adjustable attachment point of the three-point hitch such that the second adjustable attachment point releases the corresponding second coupler point of the implement. The user may then lower the hitch, which disengages the implement, and drive the working vehicle away from the implement.

### BRIEF DESCRIPTION OF THE SEVERAL VIEWS OF THE DRAWINGS

FIG. 1 is a drawing illustrating a three-point quick hitch in an unlocked state, according to various aspects of the present disclosure;

FIG. 2 is a drawing illustrating a three-point quick hitch in a locked state, according to various aspects of the present disclosure;

FIG. 3 is a drawing illustrating a rear view of a three-point quick hitch and control module, according to various aspects of the present disclosure; and

FIG. 4 is a flow chart illustrating a method of attaching and detaching an implement to a three-point quick hitch, according to various aspects of the present disclosure.

### DETAILED DESCRIPTION

According to aspects of the present disclosure, a three-point quick hitch includes two adjustable attachment points that may be operated by a user from a cab of a working vehicle. When the hitch has been positioned under a desired implement, the user raises the hitch using a standard hydraulic system of the working vehicle to engage the adjustable attachment points of the hitch to corresponding coupler points of the implement. Once the corresponding coupler points of the implement are engaged, the user may individually adjust latches of two adjustment points of the hitch via a control module, without leaving the cab of the working vehicle, to secure the implement to the hitch. A light-emitting diode array may be provided for each latch indicates a position of the associated latch. Further, the three-point quick hitch can include its own electrical system, so the hitch does not have to tap into a battery or hydraulic system of the working vehicle.

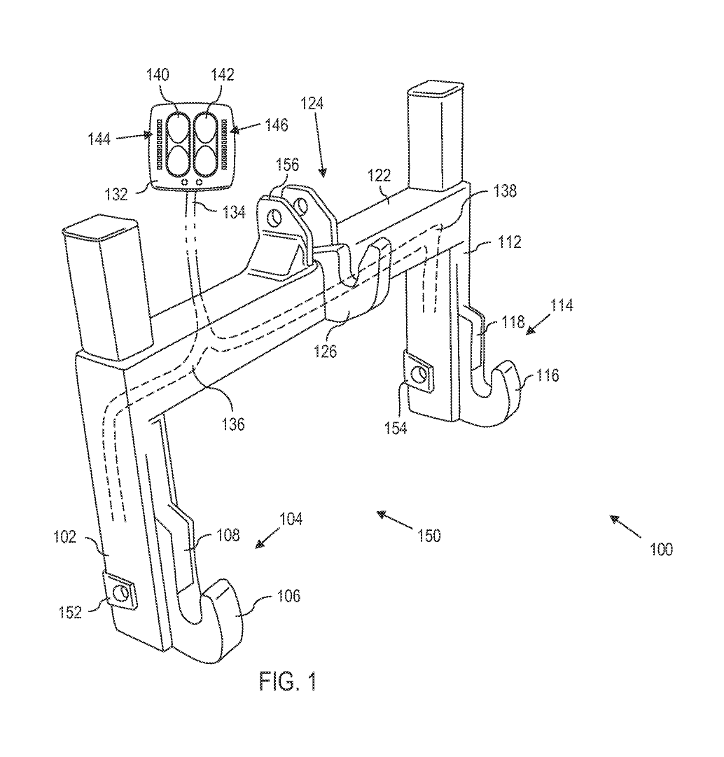

Referring now to the drawings, and in particular FIG. 1, a three-point quick hitch 100 includes a first arm 102 with a first adjustable attachment point 104. In the embodiment shown, the first adjustable attachment point 104 includes a stationary hook 106 and an adjustable latch 108. The three-point quick hitch 100 further includes a second arm 112 with a second adjustable attachment point 114. In the embodiment shown in FIG. 1 (similar to the first adjustable attachment point 104), the second adjustable attachment point 114 includes a stationary hook 116 and an adjustable latch 118. A crossbar 122 extends between the first arm 102 and the second arm 112 and includes a third attachment point 124, which may be fixed or adjustable. For example, the third attachment point may just include a hook 126 (as shown) or may include a hook 126 and an adjustable latch (not shown) similar to the adjustable latches 108, 118 of the adjustable attachment points 104, 114.

The adjustable latches 108, 118 are individually controlled by a control module 132 that couples to each of the adjustable latches 108, 118 via an electronic cable 134, which splits off into a first sub-cable 136 and a second sub-cable 138. The first sub-cable 136 travels down the first arm 102 and couples to the adjustable latch 108 of the first adjustable attachment point 104. Similarly, the second sub-cable 138 travels down the second arm 112 and couples to the adjustable latch 118 of the second adjustable attachment point 114. Thus, the sub-cables 136, 138 allow the second adjustable attachment point 114 to adjust using an electrical signal separate from the electrical signal of the first adjustable attachment point 104. If the third attachment point 124 is adjustable, then a third sub-cable may go to the third attachment point.

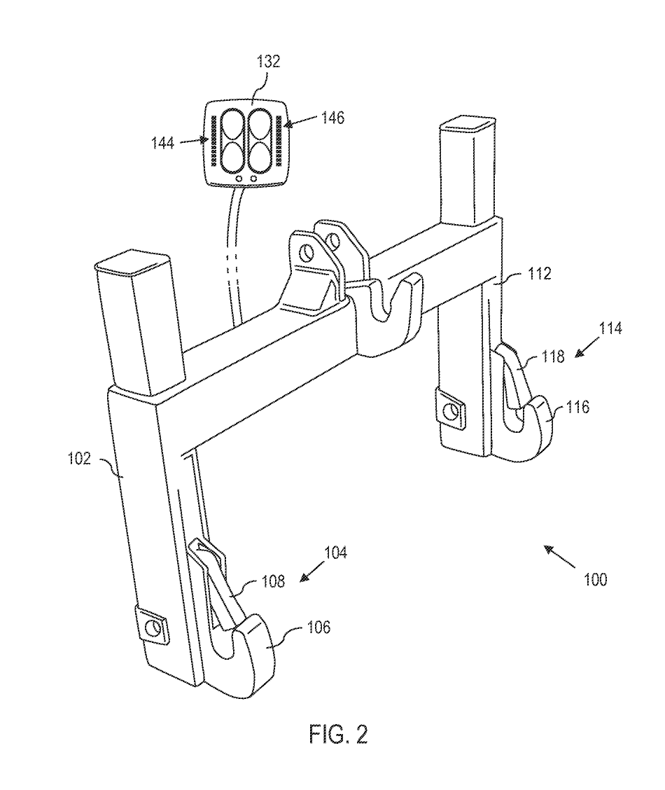

The control module 132 includes a first control 140 and a second control 142. When a user activates the first control 140 in a first direction, the first adjustable attachment point 104 (e.g., via the adjustable latch 108 as shown) moves toward a locked position (see FIG. 2). When the user activates the first control 140 in a second direction, the first adjustable attachment point 104 moves toward an unlocked position (shown in FIG. 1). Similarly, when the user activates the second control 142 in a first direction, the second adjustable attachment point 114 (e.g., via the adjustable latch 128 as shown) moves toward a locked position (see FIG. 2). When the user activates the second control 142 in a second direction, the second adjustable attachment point 114 moves toward an unlocked position (shown in FIG. 1).

A first indicator 144 indicates the position of the first adjustable attachment point 104, and a second indicator 146 indicates the position of the second adjustable attachment point 114. In the embodiment shown in FIG. 1, the indicators 144, 146 are linear light-emitting diode (LED) arrays that indicate several different positions of the adjustable attachment points 104, 114. For example, as shown, there are twelve different LEDs per array, so the indicators 144, 146 can show the position of the attachment point in twelve different positions: unlocked (e.g., one LED lit up), locked (e.g., all LEDs lit up), and ten positions in various stages of locked/unlocked. Thus, the indicators 144, 146 are not binary indicators (e.g., do not only show locked and unlocked), but discrete indicators that indicate more than two positions.

The hitch 100 further includes an attachment mechanism 150 including a first pin coupler 152, a second pin coupler 154, and a third pin coupler 156. Through the attachment mechanism 150, the hitch 100 may be coupled to a standard working vehicle (e.g., a tractor).

The individual controls 144, 146 allow the first attachment point 104 to be adjusted independently of the second attachment point 114. For example, the first attachment point 104 may be placed in an unlocked position while the second attachment point 114 is in the locked position. As another example, the first attachment point 104 may be placed in a three-fourths-unlocked position while the second attachment point 114 is in a half-locked position. The individual control of the adjustable attachment points 104, 114 allows the user to compensate for variations, flaws, damage, etc. to the adjustable attachment points 104, 114. For example, if the first adjustable attachment point 104 adjusts more slowly than the second adjustable attachment point 114, then the user may activate the control 140 for the first adjustable attachment point 104 longer than the control 142 for the second adjustable attachment point 114. That way, both adjustable attachment points 104, 114 may be placed in the locked position despite differences in activation speed.

Further, the control of the positions of the adjustable attachment points 104, 114 (e.g., via the user-controlled pivoting of the adjustable latches 108, 118) is independent of control of the hitch 100 itself. For example, instead of the entire hitch 100 or the entire arms 102, 112 angling themselves, only an adjustable portion of the adjustable attachment points 104, 114 move (i.e., the hitch and the arms do not adjust from signals from the control module). That way once an implement is coupled to the hitch 100, the entire hitch 100 may be angled to start securing the implement (if the working vehicle to which the hitch 100 is coupled may angle the hitch), and the adjustable attachment points 104, 114 may be placed in the locked position to further secure the implement.

As mentioned above, the adjustable attachment points 104, 114 may be powered by an electrical system that is separate from the working vehicle to which the hitch 100 is attached. For instance, the control module 132 may house a battery compartment that holds a battery for powering the electrical system. Thus the control module 132 may be operated without affecting any power systems (electrical, hydraulic, etc.) of the working vehicle. However, the adjustable attachment points 104, 114 may be powered by an electrical system of the vehicle if desired. The fully electrical control of the first and second adjustable attachment points 104, 114 allow for easier repair if the systems stop working. For example, it is much easier to replace a wire than a hose or conduit for a hydraulic system.

Turning now to FIG. 2, the three-point quick hitch 100 of FIG. 1 is shown with the first and second attachment points 104, 114 in the locked position. Thus, if coupling points of an implement are in the hooks 106, 116, then the first and second latches 108, 118 secure the implement to the hitch 100. The indicators 144, 146 of the control module 132 show that the latches 108, 118 are in the locked position.

As shown, the adjustable attachment points 104, 114 adjust by using latches 108, 118 that pivot from a point where the latches 108, 118 couple to the first and second arms 102, 112, respectively. However, the adjustable attachment points 104, 114 may adjust in other ways. For example, the hooks 106, 116 may pivot up and close against the respective arm 102, 112. As another example, the hooks 106, 116 may move linearly up and down their respective arms 102, 112 to close on stationary latches.

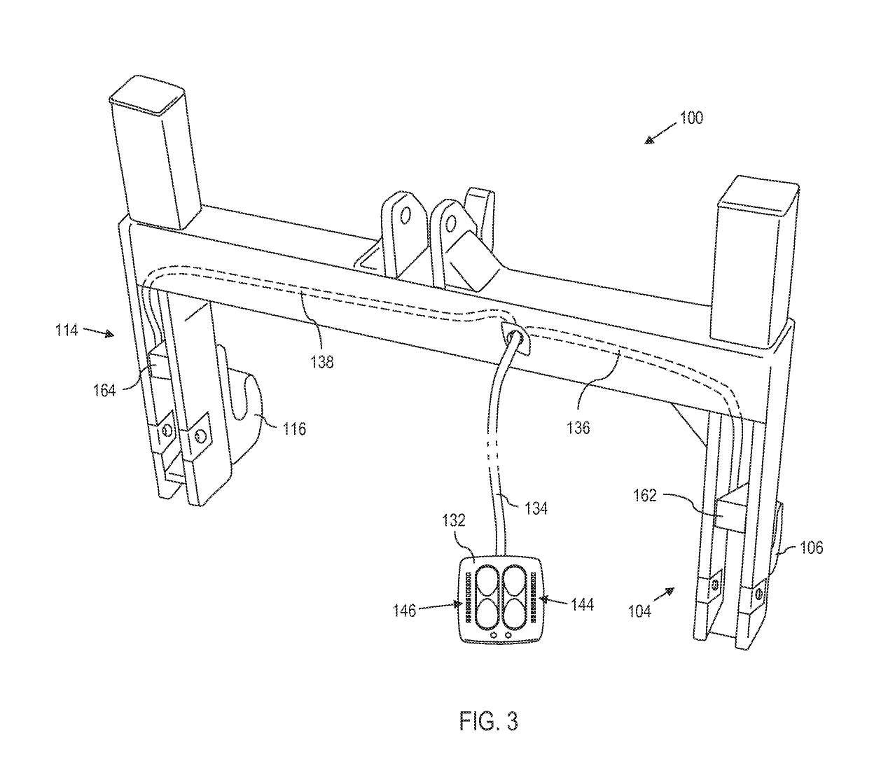

FIG. 3 shows a rear view of the hitch 100. As mentioned above, the electrical cable 134 from the control module 132 splits into a first sub-cable 136 and a second sub-cable 138 that run to the first adjustable attachment point 104 and second adjustable attachment point 114, respectively. The adjustable attachment points 104, 114 each include an electric motor 162, 164 that move an adjustable portion of the adjustable attachment points 104, 114. For example, the electric motors 162, 164 may pivot the latches (108, 118 of FIG. 1) to secure the implement to the hitch 100. In other embodiments, the electric motors may pivot or linearly move the hooks 106, 116. These localized motors 162, 164 allow for less movement in parts of the hitch 100 as opposed to one motor that may control both adjustable attachment points. Further, the motors 162, 164 should be resistant to dirt, dust, water, vibrations, etc. For example, the control module 132 and motors 162, 164 may be similar to a trim tab system.

As shown, the indicators 144, 146 indicate that one adjustable attachment point is about halfway locked, while the other adjustable attachment point is one-fourth unlocked (i.e., three-fourths to the locked position).

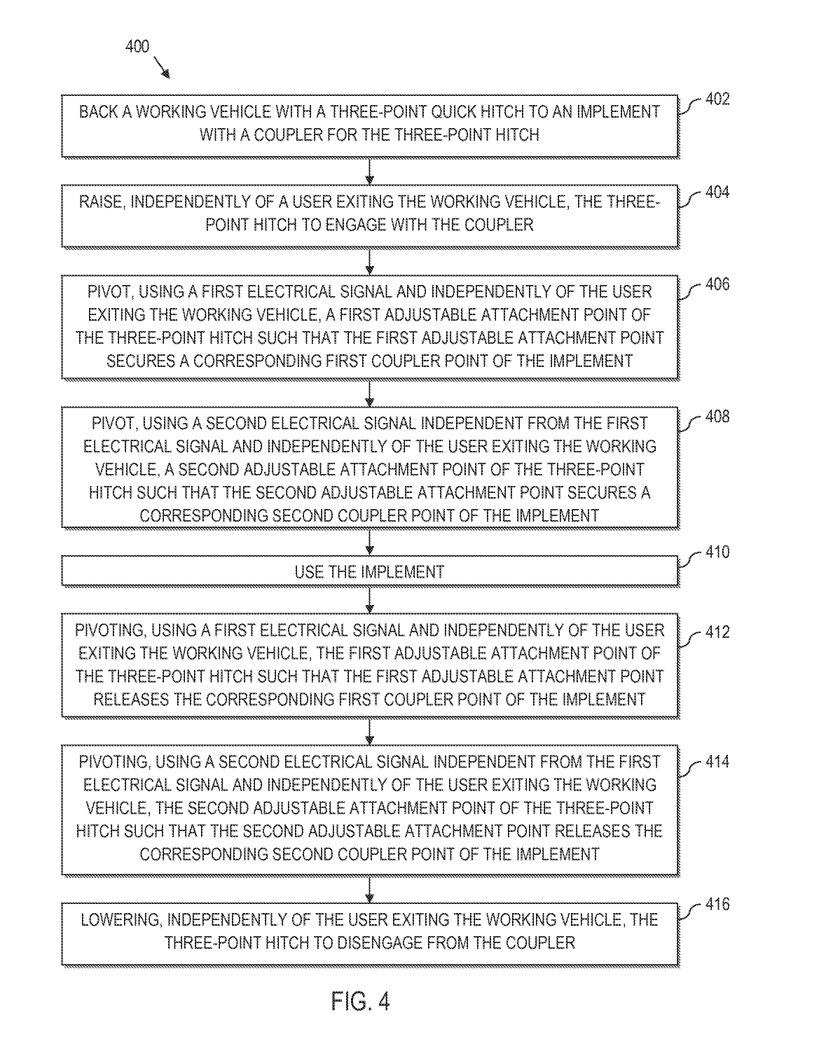

FIG. 4 illustrates a method 400 for attaching and detaching an implement to and from a three-point quick hitch mounted to a working vehicle. At 402, a user backs the working vehicle with the three-point hitch to the implement, which has a corresponding coupler to the three-point hitch. When backing up to the implement, the attachment points of the hitch will be lower than and aligned approximately vertically with the corresponding coupling points on the implement.

At 404, the user raises the three-point hitch to engage with the coupler of the implement without exiting the working vehicle. Thus, the user remains within a cab of the working vehicle, does not dismount from the working vehicle, etc. when raising the three-point hitch. For example, the user may activate a hydraulic system of the working vehicle to raise the hitch. When the hitch is raised, the hooks of the attachment points engage the corresponding coupler points of the implement. Thus, the implement is coupled to the hitch, but not yet secured.

At 406, the first adjustable attachment point of the hitch is pivoted (e.g., the latch is pivoted) to secure a corresponding first coupler point of the of the implement to the hitch. This is done without the user exiting the working vehicle. In other words, this is done independently of the user exiting the working vehicle. For example, the user may use the control module, which is available to the user while the user is in/on the working vehicle, to send a first signal that is independent of the electrical system of the working vehicle to the adjustable attachment point.

At 408, the second adjustable attachment point of the hitch is pivoted (e.g., the latch is pivoted) to secure a corresponding second coupler point of the implement to the hitch, which is done without the user exiting the working vehicle. For example, the user may use the control module, which is available to the user while the user is in/on the working vehicle, of the three-point hitch to send a second signal that is independent of the electrical system of the working vehicle to the adjustable attachment point. Further, the signal used to pivot the second adjustable attachment point is independent of the first signal to pivot the first adjustable attachment point.

At 410, the user uses the implement as desired.

When the user is finished with the implement, at 412, the first adjustable attachment point of the hitch is pivoted to release the corresponding first coupler point of the implement. As with the pivoting of 406 above, this is done without the user exiting the working vehicle. For example, the uses the control module of the hitch to send the first signal to release the implement.

At 414, the second adjustable attachment point of the hitch is pivoted to release the corresponding second coupler point of the implement. As with the pivoting of 408 above, this is done without the user exiting the working vehicle. For example, the uses the control module of the hitch to send the second signal independent of the first signal to release the implement.

At 416, the user lowers the hitch to disengage the implement without exiting the working vehicle and drives away. This method 400 allows a user to attach, secure, use, release, then detach an implement from a working vehicle without ever leaving the working vehicle.

As will be appreciated by one skilled in the art, aspects of the present invention may be embodied as a system, method, or combination thereof. Accordingly, aspects of the present invention may take the form of an entirely hardware embodiment or an embodiment combining software (including firmware, resident software, micro-code, etc.) and hardware aspects that may all generally be referred to herein as a “circuit,” “module” or “system.” Furthermore, aspects of the present invention may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. However, a computer-readable storage medium does not include signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

Aspects of the present invention are described herein with reference to flowchart illustrations and/or block diagrams of methods, and apparatus (systems) according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The flowchart and block diagrams in the Figures illustrate the architecture, functionality, and operation of possible implementations of systems and methods according to various embodiments of the present disclosure. In this regard, each block in the flowchart or block diagrams may represent a module, segment, or specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

1. A three-point quick hitch comprising:
a first arm;
a first electrically adjustable attachment point coupled to the first arm;
a second arm;
a second electrically adjustable attachment point coupled to the second arm;
a third attachment point coupled between the first arm and the second arm; and
an attachment mechanism to attach the three-point quick hitch to a vehicle;
wherein the first electrically adjustable attachment point adjusts independently from the second electrically adjustable attachment point.

2. The three-point quick hitch of claim 1, wherein the first electrically adjustable attachment point adjusts independently of the first arm.

3. The three-point quick hitch of claim 2, wherein the second electrically adjustable attachment point adjusts independently of the second arm.

4. The three-point quick hitch of claim 1 further comprising:
a crossbar coupled between the first arm and the second arm, wherein the third attachment point is coupled to a center of the crossbar.

5. The three-point quick hitch of claim 4, wherein the attachment mechanism includes:
a first pin coupler attached to the first arm;
a second pin coupler attached to the second arm; and
a third pin coupler attached to the crossbar

6. The three-point quick hitch of claim 1, wherein the third attachment point is a fixed attachment point.

7. The three-point quick hitch of claim 1 further including a control module that controls the first electrically adjustable attachment point and the second electrically adjustable attachment point.

8. The three-point quick hitch of claim 7, wherein the control module includes:
a first indicator of a position of the first electrically adjustable attachment point; and
a second indicator of a position of the second electrically adjustable attachment point.

9. The three-point quick hitch of claim 8, wherein:
the first indicator is a first light-emitting-diode array; and
the second indicator is a second light-emitting-diode array.

10. The three-point quick hitch of claim 1, wherein:
the first electrically adjustable attachment point adjusts electrically independently of hydraulics; and
the second electrically adjustable attachment point adjusts electrically independently of the hydraulics.

11. The three-point quick hitch of claim 10, wherein:
the first electrically adjustable attachment point adjusts using an electrical system independent of an electrical system of the vehicle; and
the second electrically adjustable attachment point adjusts using the electrical system independent of an electrical system of the vehicle.

12. The three-point quick hitch of claim 10, wherein:
the first electrically adjustable attachment point adjusts using a first electrical system independent of an electrical system of the vehicle; and
the second electrically adjustable attachment point adjusts using a second electrical system independent of an electrical system of the vehicle, wherein the second electrical system is independent of the first electrical system.

13. The three-point quick hitch of claim 10, wherein:
the first electrically adjustable attachment point adjusts using an electrical system of the vehicle; and
the second electrically adjustable attachment point adjusts using the electrical system of the vehicle.

14. The three-point quick hitch of claim 1, wherein the first electrically adjustable attachment point adjusts by pivoting from a point where the first electrically adjustable attachment point couples to the first arm.

15. The three-point quick hitch of claim 14, wherein the first electrically adjustable attachment point adjusts by pivoting a latch from a point where the latch of the first electrically adjustable attachment point couples to the first arm.

16. The three-point quick hitch of claim 14, wherein the first electrically adjustable attachment point adjusts by pivoting a hook from a point where the hook of the first electrically adjustable attachment point couples to the first arm.

17. The three-point quick hitch of claim 1, wherein the first electrically adjustable attachment point adjusts by moving linearly along the first arm.

18. A three-point quick hitch comprising:
a first arm;
a first electrically adjustable attachment point coupled to the first arm, wherein the first electrically adjustable attachment point adjusts independently of the first arm and adjusts by pivoting in from a point where the first electrically adjustable attachment point couples to the first arm;
a second arm;
a second electrically adjustable attachment point coupled to the second arm, wherein the second electrically adjustable attachment point adjusts independently of the first electrically adjustable attachment point, adjusts independently of the second arm, and adjusts by pivoting in from a point where the second electrically adjustable attachment point couples to the second arm;
a crossbar coupled between the first arm and the second arm;
a fixed attachment point coupled to the crossbar;
an attachment mechanism to attach the three-point quick hitch to a vehicle, wherein the attachment mechanism includes:
a first pin coupler attached to the first arm;
a second pin coupler attached to the second arm; and
a third pin coupler attached to the crossbar; and
a control module that controls the first electrically adjustable attachment point and the second electrically adjustable attachment point, wherein the control module includes:
a first light-emitting-diode array that indicates a position of the first electrically adjustable attachment point; and
a second light-emitting-diode array that indicates a position of the second electrically adjustable attachment point;
wherein the first electrically adjustable attachment point and the second electrically adjustable attachment point adjust electrically independently of hydraulics of the vehicle.

19. A method comprising:
backing a working vehicle with a three-point quick hitch to an implement with a coupler for the three-point hitch;
raising, independently of a user exiting the working vehicle, the three-point hitch to engage with the coupler;
pivoting, using a first electrical signal and independently of the user exiting the working vehicle, a first electrically adjustable attachment point of the three-point hitch such that the first electrically adjustable attachment point secures a corresponding first attachment point of the coupler; and
pivoting, using a second electrical signal independent from the first electrical signal and independently of the user exiting the working vehicle, a second electrically adjustable attachment point of the three-point hitch independently from the first electrically adjustable attachment point of the three-point hitch such that the second electrically adjustable attachment point secures a corresponding second attachment point of the coupler.

20. The method of claim 19 further comprising:
pivoting, using a first electrical signal and independently of the user exiting the working vehicle, the first electrically adjustable attachment point of the three-point hitch such that the first electrically adjustable attachment point releases the corresponding first attachment point of the coupler;
pivoting, using a second electrical signal independent from the first electrical signal and independently of the user exiting the working vehicle, the second electrically adjustable attachment point of the three-point hitch such that the second electrically adjustable attachment point releases the corresponding second attachment point of the coupler; and
lowering, independently of the user exiting the working vehicle, the three-point hitch to disengage from the coupler.
